(19) United States
(12) Patent Application Publication
(10) Pub. No.: US 2007/0122309 A1
(43) Pub. Date: May 31, 2007

(54) Specimen analyzer and specimen suction device

(75) Inventors: Takaaki Nagai, Kobe-shi (JP); Masaharu Shibata, Kobe-shi (JP)

Correspondence Address: SUGHRUE MION, PLLC, 2100 PENNSYLVANIA AVENUE, N.W., SUITE 800, WASHINGTON, DC, 20037, US

(73) Assignee: SYSMEX CORPORATION

(21) Appl. No.: 11/541,633

(22) Filed: Oct. 3, 2006

(30) Foreign Application Priority Data
Oct. 3, 2005 (JP) 2005-290249

(51) Int. Cl. G01N 35/00

(52) U.S. Cl. 422/63

(57) ABSTRACT

To present a specimen analyzer capable of executing positively operations of washing of a suction tube which returns to its original profile immediately even subjected to external force. The suction tube is made of superelastic alloy, and a washing unit for washing the suction tube is provided. And the specimen analyzer is provided with a sample preparation unit for preparing a sample by a specimen which is discharged from the suction tube, a movement mechanism for moving said suction tube, and an analysis unit for analyzing a sample preparedby said sample preparation unit.

### FIELD OF THE INVENTION

The present invention relates to a specimen analyzer for sucking a blood specimen, urine specimen or the like accommodated in a specimen container and analyzing the specimen and to a specimen suction device for sucking said specimens.

### BACKGROUND

Specimen analyzers for automatically analyzing specimens of blood, urine or the like taken from a subject being tested have been used extensively. For analysis by such specimen analyzer, as a container for accommodating a specimen, sealed container such as evacuated blood-collection tube for collected blood or open container upper portion of which is made open are used. And one type of specimen analyzer is exclusively used for open container, and the other type is capable of coping with both sealed container and open container. In addition, such a specimen analyzer which is equipped with a carrying mechanism for carrying a number of containers automatically and executes automatic suction of specimen from each of containers, and another specimen analyzer which sucks specimens from containers one by one manually are available.

Further, many of specimen analyzers of this sort comprise a suction tube for sucking a specimen from a container, a penetrating-type washing member for washing the suction tube, and a sample preparation unit for preparing a sample by mixing a specimen and a reagent, and are designed to wash the suction tube used for suction of the specimen by the washing member, to move the suction tube to the sample preparation unit and to cause the suction tube to discharge a predetermined amount of specimen at the sample preparation unit. For example, U.S. Pat. No. 5,592,959 discloses a specimen analyzer comprising a penetrating-type washing member, which is constituted to wash a suction tube while it is being penetrated through penetrating path of the washing member.

With specimen analyzers of these types, it is necessary to insert a suction tube into an insertion port provided to the sample preparation unit and to move up and down the suction tube in the penetrating path of the washing member, thereby requiring high-positioning accuracy, high-assembly accuracy, high-dimensional accuracy of parts or the like. Further, along with miniaturization of analyzer and of amount of specimen prevailing recently, high dimensional accuracy or the like have been demanded. On the other hand, it is necessary that inside diameter of the penetrating path of penetrating-type washing member is slitly, i.e. not much, larger than outside diameter of the suction tube because of the structure of the penetrating-type washing member. Therefore normal washing operation is not possible even if the suction tube is bent slightly.

Further, when a specimen is sucked manually from an open container, in order to prevent erroneous suction operation, an operator preferably executes manipulations while confirming that end of the suction tube is being inserted into the specimen. However, in some cases, it is hard for the operator to confirm the end of the suction tube depending on position of the suction tube in a specimen analyzer, place of installation of the specimen analyzer, physical size of the operator or the like. If this is the case, the operator may attempt to execute suction manipulations by pressing interior surface of the container against the suction tube. However, there has been such a draw back that with conventional analysis apparatus equipped with an ordinary suction tube made of higher hardness metal (e.g., stainless steel), the suction tube causes plastic deformation if subjected to repeated external forces in transverse direction or excessive external forces, and normal operation is not possible.

### SUMMARY

The scope of the present invention is defined solely by the appended claims, and is not affected to any degree by the statements within this summary.

The first aspect of the present invention relates to a specimen analyzer comprising:

a suction tube made of superelastic alloy for sucking a specimen from a specimen container whose upper portion is open;

a sample preparation unit having an insertion port for inserting the suction tube and preparing a sample by a specimen which is discharged from the suction tube inserted into the insertion port;

a movement mechanism for moving said suction tube between suction position for said suction tube to suck a specimen and insertion position where said suction tube is inserted into insertion port of said sample preparation unit; and

an analysis unit for analyzing a sample prepared by said sample preparation unit.

The second aspect of the present invention relates to a specimen analyzer comprising:

a suction tube made of superelastic alloy for sucking a specimen from a specimen container whose upper portion is open;

a washing unit having a penetrating path through which is penetrating said suction tube, a supplying path for supplying washing solution to said penetrating path and a drainage path for draining the washing solution from said penetrating path;

a movement mechanism for relatively moving said suction tube and said washing unit in lengthwise direction of said suction tube; and

an analysis unit for analyzing a specimen sucked by said suction tube.

The third aspect of the present invention relates to a specimen suction device comprising:

a suction tube made of superelastic alloy for sucking a specimen from a specimen container whose upper portion is open;

a movement mechanism for moving said suction tube; and

a specimen suction unit connected to said suction tube for sucking a specimen by said suction tube.

### BRIEF DESCRIPTION OF THE DRAWINGS

FIG. 1 is a perspective view showing whole specimen analyzer relating to an embodiment;

FIG. 2 is a front view of the specimen analyzer shown in FIG. 1;

FIG. 3 is a perspective view of the specimen analyzer shown in FIG. 1 after housing is removed;

FIG. 4 is a front elevation of the specimen analyzer shown in FIG. 1 after housing is removed;

FIG. 5 is a front elevation of a horizontal driving unit of the specimen analyzer shown in FIG. 1;

FIG. 6 is a front elevation of a vertical driving unit and horizontal driving unit of the specimen analyzer shown in FIG. 1;

FIG. 7 is an explanatory drawing showing left side of the vertical driving unit and horizontal driving unit of the specimen analyzer shown in FIG. 1;

FIG. 8 is a side sectional view showing composition of a washing unit;

FIG. 9 is an explanatory drawing showing left side of the vertical driving unit of the specimen analyzer shown in FIG. 1;

FIG. 10 is a sectional view looked at line C-C in FIG. 8;

FIG. 11 is first half of fluid circuit diagram of the specimen analyzer shown in FIG. 1;

FIG. 12 is last half of fluid circuit diagram of the specimen analyzer shown in FIG. 1;

FIG. 13 is a fluid circuit diagram showing periphery of a drainage chamber;

FIG. 14 is a fluid circuit diagram showing periphery of a diaphragm pump;

FIG. 15 is a control block diagram of the specimen analyzer shown in FIG. 1;

FIG. 16 is a flowchart showing flow of operations of the specimen analyzer shown in FIG. 1;

FIG. 17 is a schematic diagram showing an example of deformation of the suction tube;

FIG. 18 is a front view of the vertical driving unit and the horizontal driving unit showing positional relationship between the suction tube and the washing unit when the suction tube is at initial position; and

FIG. 19 is a side sectional view showing state where the suction tube is inserted into upper opening of a second mixing chamber.

### DETAILED DESCRIPTION OF THE EMBODIMENT

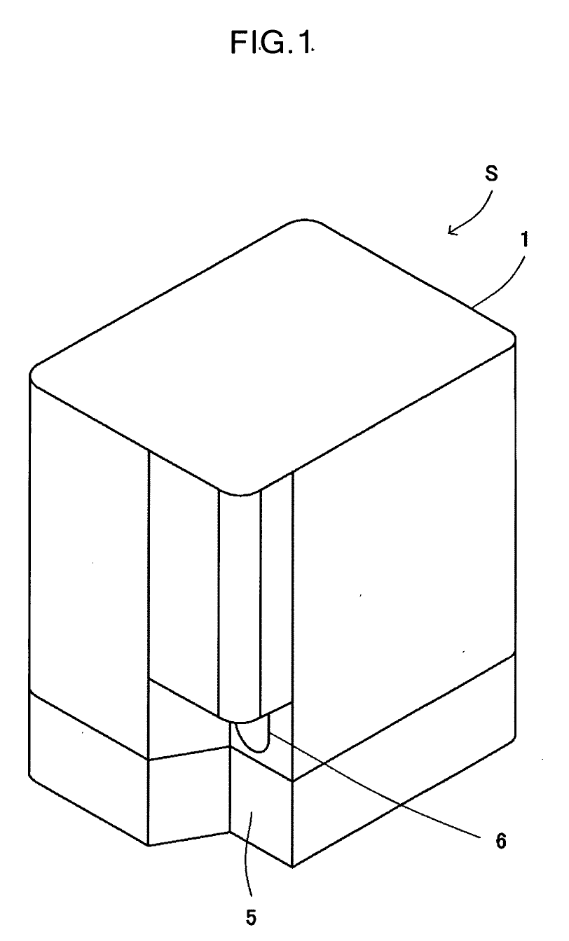

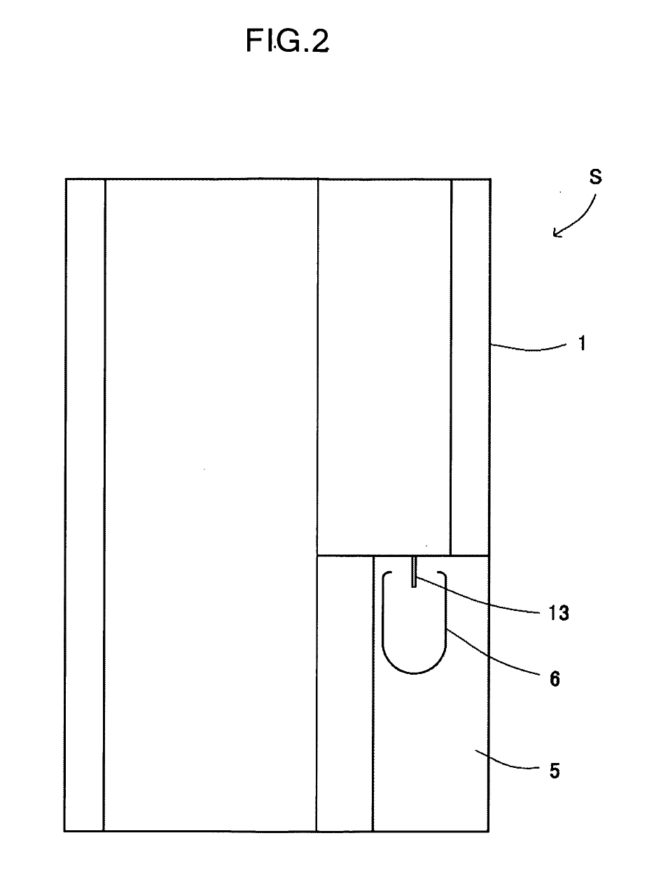

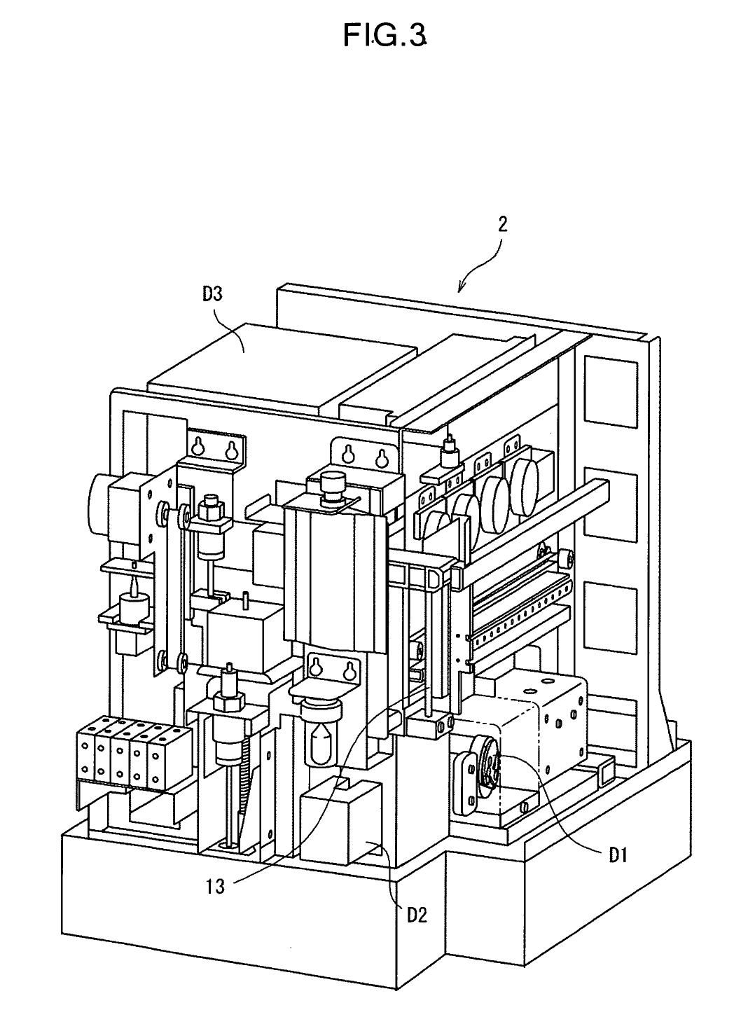

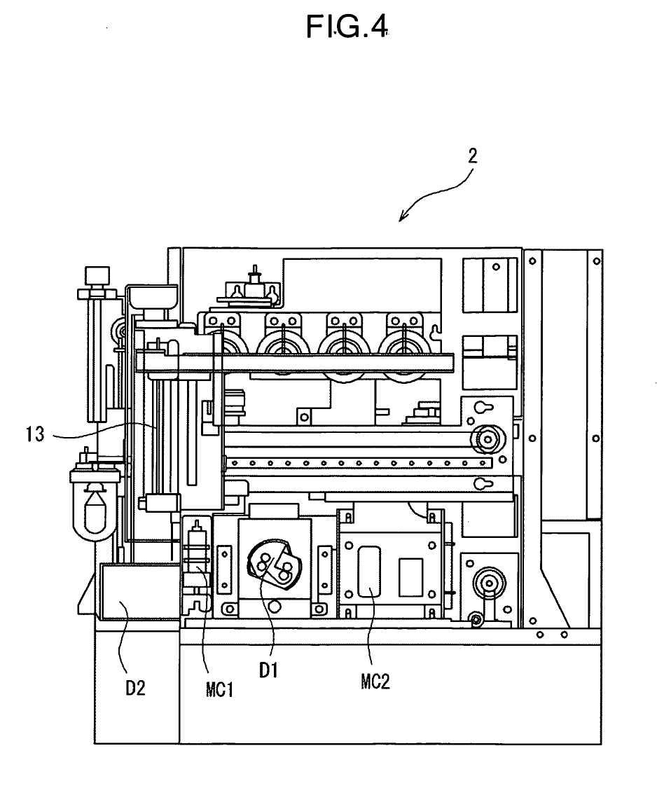

FIG. 1 is a perspective view showing whole specimen analyzer S relating to an embodiment, FIG. 2 is a front view of the specimen analyzer S, FIG. 3 is a perspective view of the specimen analyzer S showing state where housing 1 is removed, and FIG. 4 is a front elevation of the same after the housing is removed.

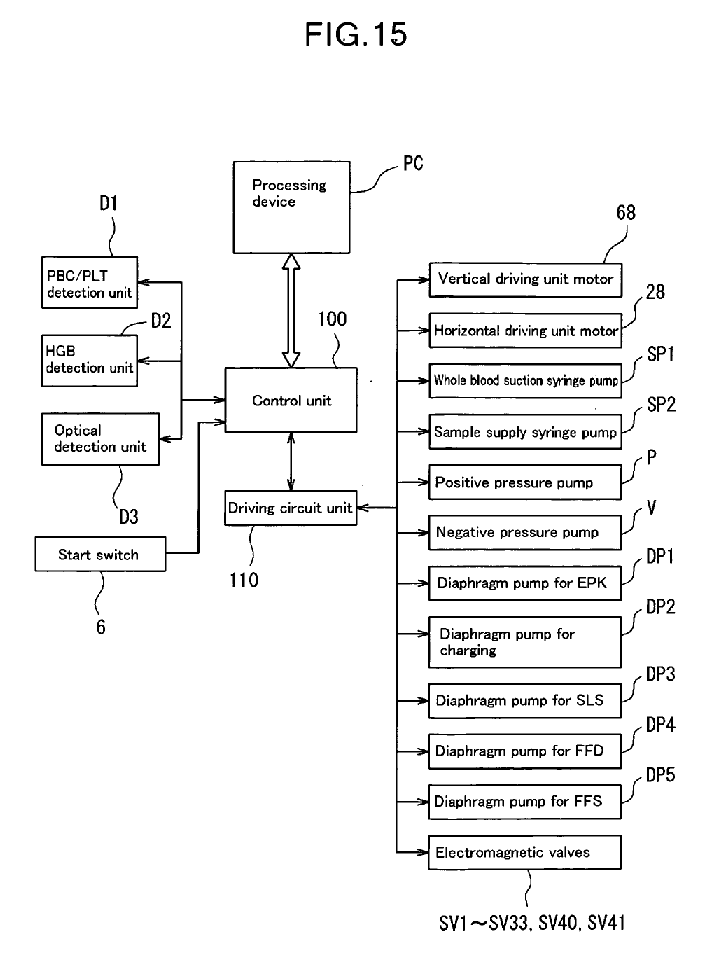

Said specimen analyzer S is communicably connected with a processing device PC having a display, an input device, a CPU and memory or the like (typically, a personal computer to which are installed necessary computer programs) (see FIG. 15), and a sample analysis system is composed of the specimen analyzer S and the processing device PC. To the processing device PC is installed software for manipulations of the specimen analyzer S, various analysis related settings, display of analysis results or the like, and it is possible to give a command to the specimen analyzer S and to receive measurement data from the specimen analyzer S through communication with the specimen analyzer S. The specimen analyzer S is an apparatus (blood analysis apparatus) for measurements of blood (sample) accommodated in a blood-collection tube 3 which is a container whose upper portion is open (initial sample container), and comprises primarily an mesurement device 2 and a housing 1 for accommodating the mesurement device 2.

The housing 1 is made from synthetic resin and rust-proofed steel plate or the like and is fixed to the mesurement device 2 using fastening means such as bolts or the like. At right lower portion of front of the housing 1 (left-side face in FIG. 1) is formed a recess 5 and a suction tube 13, which will be described later, is protruded from upper plane of the recess 5 (see FIG. 2). This arrangement allows an operator to move the blood-collection tube 3 now he/she holds and to insert the suction tube 13 into the blood-collection tube 3 from lower portion. Besides, a start switch 6 composed of microswitch is provided in the back of the recess 5, and the operator can give an instruction for blood suction by touching the start switch 6 while the suction tube 13 is being inserted into the blood-collection tube 3.

The mesurement device 2 includes a sample preparation unit for preparing a mixed sample for analysis by quantitative determination, dilution or the like of blood in the blood-collection tube 3, detection units D1, D2, D3 for measuring (detection) of the blood subjected to dilution or the like, and a control unit for driving and controlling electrically said sample preparation unit and the detection units. A liquid sample suction device of the present embodiment comprises, of said sample preparation unit and control unit, components or mechanism for sucking a sample from a open container.

Said sample preparation unit is a portion for adjusting mixed samples for various analyses by sucking a predetermined amount of blood from the blood-collection tube 3 inside and mixing it with a reagent in a first mixing chamber MC1 or in a second mixing chamber MC2. And the sample preparation unit includes a suction tube 13 for sucking a sample in the blood-collection tube 3, a horizontal driving unit 20 for moving the suction tube 13 horizontally, a vertical driving unit 60 for moving said suction tube 13 vertically, a suction mechanism for venting said blood-collection tube 3 inside to atmosphere and sucking the sample in the blood-collection tube 3, and a control unit for controlling operations of said horizontal driving unit, vertical driving unit and suction mechanism. The sample preparation unit relating to the present embodiment also includes a vertical driving unit 40 being moved horizontally by said horizontal driving unit 20, which vertical driving unit 40 holds said blood-collection tube 3, and is capable of moving vertically by a guide mechanism thereof.

Said suction tube 13 has transverse section in circular form, has a flow path inside elongating in longitudinal direction and a suction port for sucking a sample or air is formed around front edge thereof. Further, this suction tube 13 is a superelastic alloy pipe made of titanium-nickel alloy (Ti—Ni) which does not cause plastic deformation even if being bent, and will restore to the original straight state. As used herein the term “superelastic alloy” is meant to refer to an alloy which is bent lithely and has properties to return to its original form in the room temperature if a force is removed. Besides, lower end of the suction tube 13 is substantially horizontal plane and a suction port is opened to the lower end. Meanwhile, such suction tube 13 is not limited to those made of titanium-nickel alloy and may be made of other superelastic alloy such as copper-aluminum-nickel alloy (Cu—Al—Ni), titanium alloy (Ti), titanium-niobium-aluminum alloy (Ti—Nb—Al), copper-zinc-nickel alloy (Cu—Zn—Al) or the like.

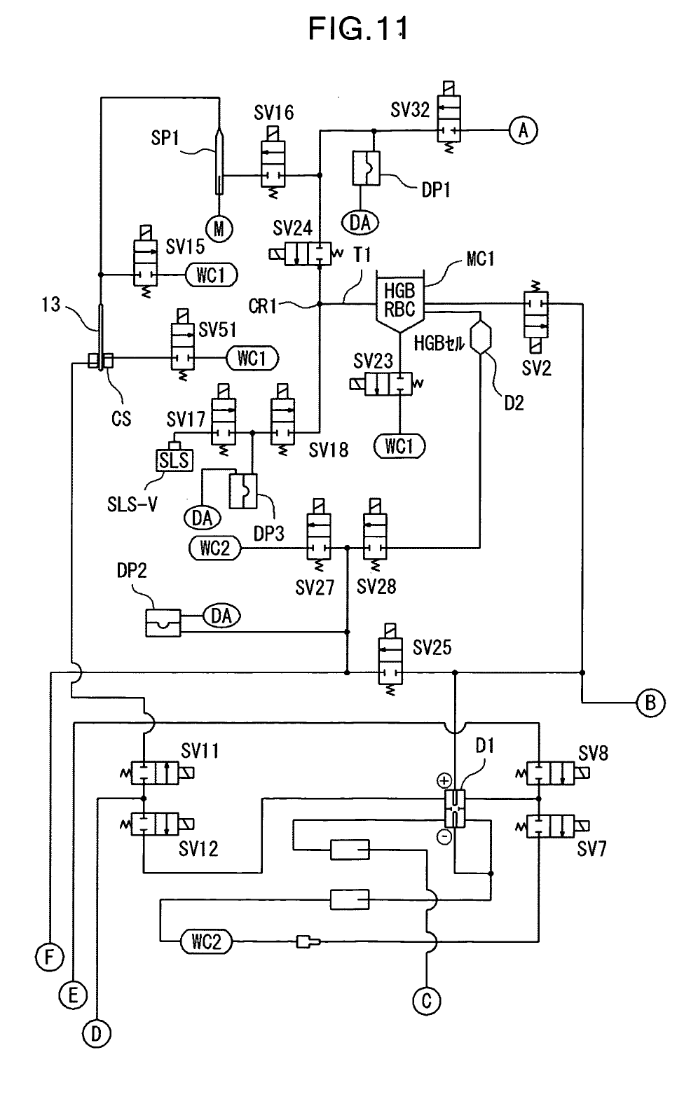

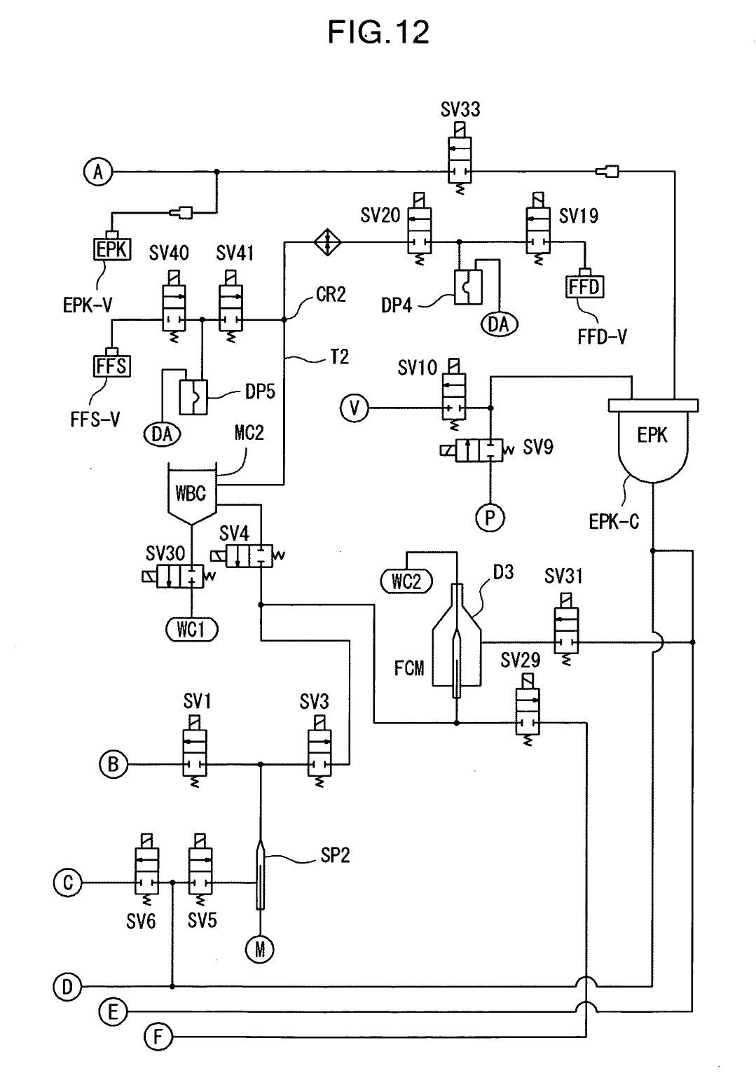

Further, as shown in the fluid circuit diagram in FIG. 11 and FIG. 12, a reagent container for accommodating reagents is provided to the mesurement device 2. Specifically, the reagent container comprises a diluting fluid container EPK-V for accommodating diluting fluid (washing solution) EPK, a hemoglobin hemolytic agent container SLS-V for accommodating hemoglobin hemolytic agent SLS, a white blood cell classification hemolytic agent container FFD-V for accommodating white blood cell classification hemolytic agent FFD, and a white blood cell classification staining fluid container FFS-V for accommodating white blood cell classification staining fluid FFS.

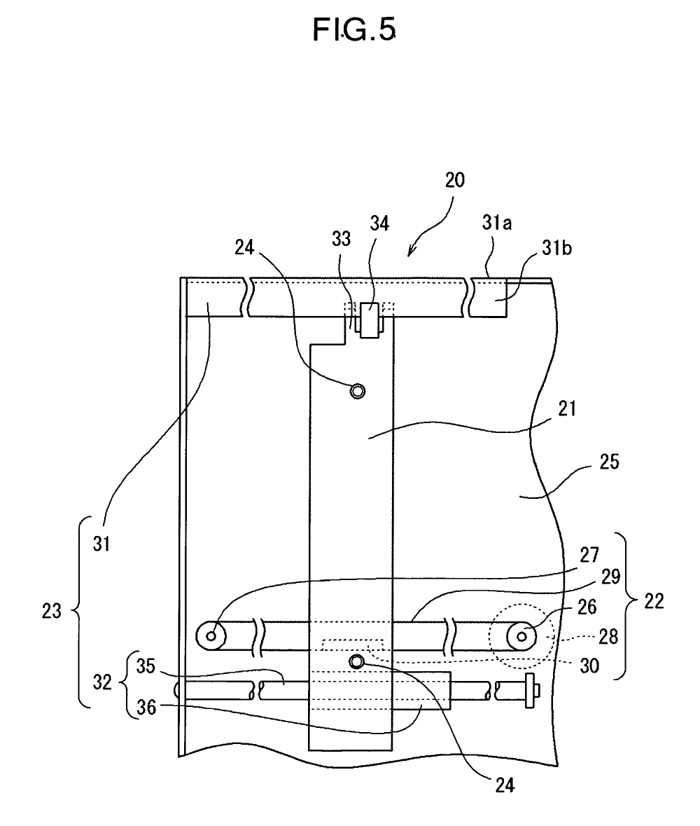

FIG. 5 is a front elevation of a horizontal driving unit of the specimen analyzer shown in FIG. 1, and the horizontal driving unit 20 includes, as illustrated, a movement panel 21 to which is fixed said vertical driving unit 40 (described indetail later), a driving mechanism 22 for moving the movement panel 21 horizontally and a guide mechanism 23 for guiding horizontal movement of said movement panel 21. Said movement panel 21 is composed of a vertically long plate made of metal or synthetic resin, and screw holes 24 for fixing a vertical driving unit 40 are provided to upper part and lower part thereof. The driving mechanism 22 is composed of a driving pulley 26 and a driven pulley pivotally mounted on the surface of a supporting panel 25 (plane at this side in FIG. 5), a stepping motor 28 disposed at rear side of said supporting panel 25 for rotating driving of said driving pulley 26, a timing belt 29 provided in tension state between said driving pulley 26 and driven pulley 27, and a connecting member 30 fixed to both inner circumference plane of the timing belt 29 and rear of said movement panel 21.

On upper-end edge of the supporting panel 25 is provided an upper guide 31 for guiding upper end of said movement panel 21, whereas to portion under said timing belt 29, that is a surface of the supporting panel 25, is provided a lower guide 32 for guiding lower part of the movement panel 21. Said guide mechanism 23 is composed of this upper guide 31 and the lower guide 32. The upper guide 31 is composed of a horizontal part 31a protruding from the upper-end edge of the supporting panel 25 to surface side, and a vertical part 31b hanging downwardly from the leading edge of this horizontal part 31a so that said vertical part 31b is grasped by a rear-side grasping piece 33 being formed around the upper end of the movement panel 21 and a surface-side grasping piece 34 having approximately C-shaped section being formed in protruding fashion to surface side around the upper end. Meanwhile, the lower guide 32 includes a guide shaft 35 disposed inparallel with movement direction of the timing belt 29 at portion under the timing belt 29 and a sliding movement member 36 having a passage therein to allow for sliding movement of this guide shaft 35, while this sliding movement member 36 is fixed to the rear of said movement panel 21.

With such a configuration as mentioned, when the stepping motor 28 is driven, the connecting member 30 fixed to the timing belt 29 moves in left or right direction in FIG. 4, and this allows for the movement panel 21, which is fixed to the connecting member 30, to move left or right direction. In this case, since upper end and lower part area of the movement panel 21 are guided by said upper guide 31 and the lower guide 32, respectively, a smooth movement is attained at movement without causing bumpy movements in fore and aft, left and right, and up and down directions.

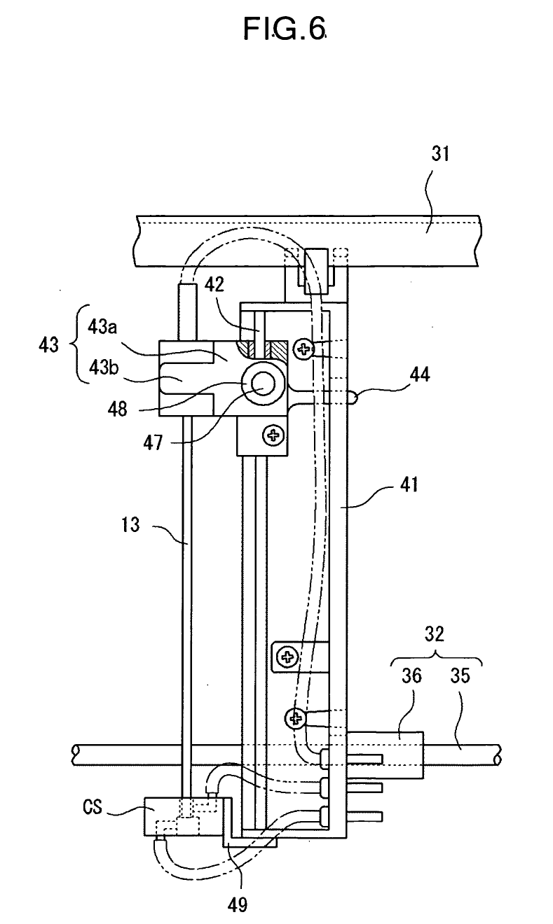

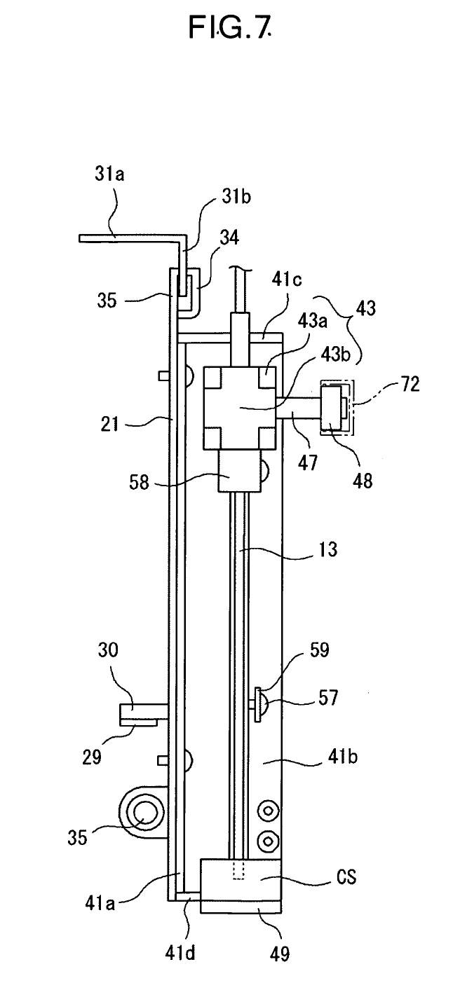

Next, the vertical driving unit 40 will be described. FIG. 6 is a front elevation of the vertical driving unit of the specimen analyzer S shown in FIG. 1 and FIG. 7 is an explanatory drawing showing left side of the vertical driving unit and the horizontal driving unit of the same. As shown in FIGS. 6-7, the vertical driving unit 40 includes a support 41, a guide shaft 42 vertically supported by this support 41 and a suction-tube retaining part 43 which retains said suction tube 13 and moves slidingly on said guide shaft 42.

Said support 41 is composed of an elongated back face part 41a which is parallel to said movement panel 21 or supporting panel 25, a similarly elongated side face part 41b provided orthogonally to this back face part 41a, and an upper face part 41c and a lower face part 41d provided orthogonally to the back face part 41a at upper end and lower end of said back face part 41a. To said side face part 41b is formed an elongated guide slit 45 for guiding a guide bar 44 protruding horizontally from the suction tube retaining part 43. Further, a guide shaft 42 is supported vertically between said upper face part 41c and lower face part 41d. Meanwhile, 46 is a notch being formed to said back face part 41a to allow for penetration of a machine screw for fixing the vertical driving unit 40 to the movement panel 21 of said horizontal driving unit 20.

The suction tube retaining part 43 includes a sliding movement part 43a in substantially cubic shape and an engagement part 43b being formed onto one plane (left plane in FIG. 6) of this sliding movement part 43a. As shown in FIG. 7, the engagement part 43b has a cross-shaped section and engages with concave part of cross-shaped section of the arm of the vertical driving unit, which will be described later, to move the suction tube 13 vertically. A shaft 47 is projectingly provided to other plane (plane of this side of the paper of FIG. 6) of the sliding movement part 43a, and a guide roller 48 is pivotally mounted to this shaft 47. The guide roller 48 engages with a guide arm of the vertical driving unit 60, which will be described later, and the suction tube retaining part 43 will move vertically being interlocked with the guide arm.

To the lower face part 41d of said support 41 is fixed via a bracket 49 a washing unit CS for washing inner and outer circumferences of the suction tube 13. Further, liquid supplying and draining nipples 50, 51, 52 are fixed to lower part of the side face part 41b of the support 41 and are respectively connected to base end of the suction tube 13 and the washing unit CS via tubes 53, 54, 55.

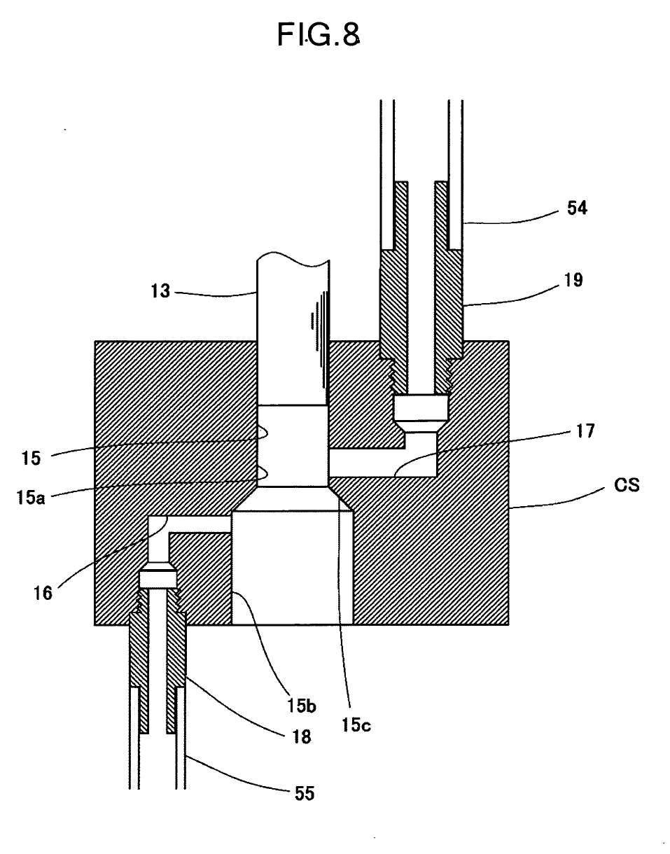

FIG. 8 is a side sectional view showing composition of the washing unit CS. As illustrated, the washing unit CS has cylindrical shape, and to this washing unit CS are provided a vertical penetrating path 15 through which the suction tube 13 is inserted loosely, a supplying path 16 for supplying washing solution to this penetrating path 15, and a drainage path 17 for draining washing solution and blood in the penetrating path 15. The penetrating path 15, supplying path 16 and drainage path 17 all have transverse section in circular form.

The penetrating path 15 comprises a small-diameter part 15a having narrower clearance with regard to the suction tube 13 and a large-diameter part 15b provided under the small-diameter part 15a having broader clearance with regard to the suction tube 13. A tapered part 15c in folding-fan shape is provided between the small-diameter part 15a and the large-diameter part 15b. Diameter of the small-diameter part 15a is designed to be slightly greater than outer shape of the suction tube 13, and this configuration allows the suction tube 13 to be loosely engaged with the small-diameter part 15a.

The supplying path 16 is opened at upper end of the large-diameter part 15b of the penetrating path 15, extends from the penetrating path 15 laterally, bent downwardly on the way, and is opened at lower plane of the washing unit CS. In the meantime, the drainage path 17 is opened at a portion close to the lower end of the small-diameter part 15a of the penetrating path 15, extends from the penetrating path 15 laterally, bent upwardly on the way, and is opened at upper plane of the washing unit CS. Besides, the drainage path 17 is configured to have a diameter greater than that of the supplying path 16.

A small nipple 18 and a large nipple 19 are mounted vertically to the washing unit CS, both are in partially embedded fashion. The small nipple 18 is connected to the supplying path 16 and is protruded downwardly from lower plane of the washing unit CS. To the lower end of the small nipple 18 is connected one end of a tube 55 for washing solution supplying. The large nipple 19 is connected to the drainage path 17 and is protruded upwardly from the upper plane of the washing unit CS. Further, to the upper end of the large nipple 19 is connected one end of a tube 54 for draining washing solution and sample.

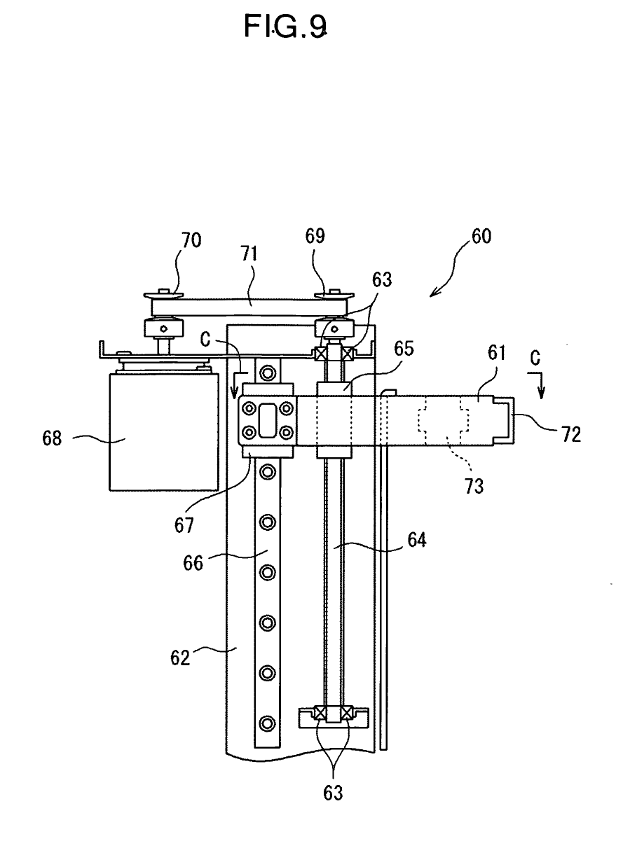

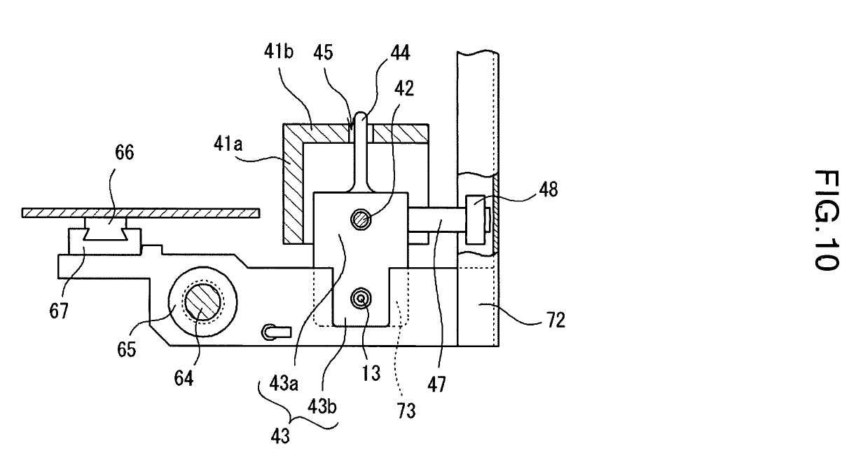

Next, the vertical driving unit 60 of the suction tube 13 will be explained in detail. FIG. 9 is an explanatory drawing showing left side of the vertical driving unit of the specimen analyzer S shown in FIG. 1. FIG. 10 is a sectional view looked at line C-C in FIG. 9. The vertical driving unit 60 constitutes together with the vertical driving unit 40 mentioned previously a suction tube movement mechanism in the liquid sample suction device according to the present invention, and includes, as shown in FIG. 9, an arm 61 comprising an elongated body disposed along with horizontal direction, a screw shaft 64 which penetrates through this arm 61 in orthogonal direction (vertical direction) and is pivotally supported by bearings 63 disposed to a supporting panel 62, and a nut portion 65 having screw part threadedly engaging with this screw shaft 64 and is fixed to said arm 61, a slide rail 66 disposed to the supporting panel 62 so as to be in parallel with said screw shaft 64, a sliding movement member 67 which is provided at one end (side end part in mesurement device 2) of said arm 61 and guides the arm 61 in vertical direction while slidably engaged with said slide rail 66, and a stepping motor 68 fixed to said supporting panel 62.

Pulleys 69, 70 are fixed respectively to upper end of said screw shaft 64 and output shaft of the stepping motor 68, and a timing belt 71 is provided in tension state between these pulleys 69, 70. Further, a guide arm 72 having ?-shaped section engaged with the guide roller 48 of said vertical driving unit 40 is fixed horizontally (vertically to the paper of FIG. 9) to other end of said arm 61 (side end part in mesurement device 2). Said arm 61 has a recess 73 having cross-shaped section on the plane opposing to the engagement part 43b having cross-shaped section of said suction tube retaining part 43, around end portion at said guide arm 72 side. As shown in FIG. 10, said engagement part 43b will be inserted into said recess 73 having cross-shaped section from arrow-X direction while keeping an appropriate clearance. It is designed that with this inserted state, the suction tube 13 will be positioned directly above the blood-collection tube 3 and when the suction tube 13 is to puncture a plug body 3a of the blood-collection tube 3, up/down movement force of the arm 61 is conveyed directly to the suction tube retaining part 43.

By appropriately controlling the stepping motor 28 of the horizontal driving unit 20 and the stepping motor 68 of the vertical driving unit 60 from control unit of said mesurement device 2, it is possible to suck a sample by the blood-collection tube 3 or to supply a sample to mixing chambers MC1, MC2, by driving the suction tube retaining part 43, namely suction tube 13, horizontally or vertically. When sucking a sample, an operation that the suction tube 13 punctures the plug body 3a of the blood-collection tube 3 is included, the engagement part 43b of the suction tube retaining part 43 engages with the recess 73 having a cross-shaped section of the arm 61, thereby conveying a large force to the suction tube retaining part 43. Meanwhile, when the suction tube 13 moves above mixing chambers MC1, MC2 and a sample is supplied to the mixing chambers MC1, MC2, a driving force of the stepping motor 68 of the vertical driving part 60 is conveyed to the suction tube retaining part 43 via the arm 61, guide arm 72 and guide roller 48.

The specimen analyzer S relating to the present embodiment includes, as shown in FIGS. 3-4, a first mixing chamber MC1 for adjusting a mixed sample for measurements relating to red blood cells, hemoglobin and blood platelet, a second mixing chamber MC2 for adjusting a mixed sample for measurements relating to white blood cells, a first detection unit D1 for measurements relating to red blood cells, a second detecting unit D2 for measurements relating to hemoglobin, and a third detection unit D3 for measurements relating to white blood cells.

Said mesurement device 2 includes, as shown in FIG. 15, a control unit 100 for controlling said sample preparation unit and measurement units D1, D2, D3. This control unit 100 is composed of CPU, ROM, and RAM. The mesurement device 2 also includes a driving circuit unit 110 for driving electromagnetic valves SV1-SV33, SV40, SV41, and various pump motors 28, 68, SP1, SP2, P, V, DP1, DP2, DP3, DP4, DP5 or the like in the fluid circuit constituting the sample preparation unit or the like. The control unit 100 drives said electromagnetic valves or the like via the driving circuit unit 110. The control unit 100 is capable of communicating with the processing device PC via a communication interface (not shown) and is capable of exchanging various signals and data with the processing device PC.

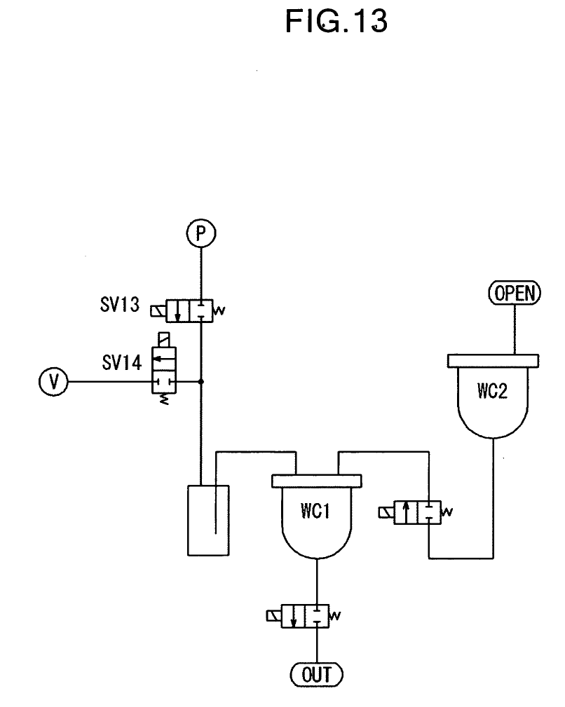

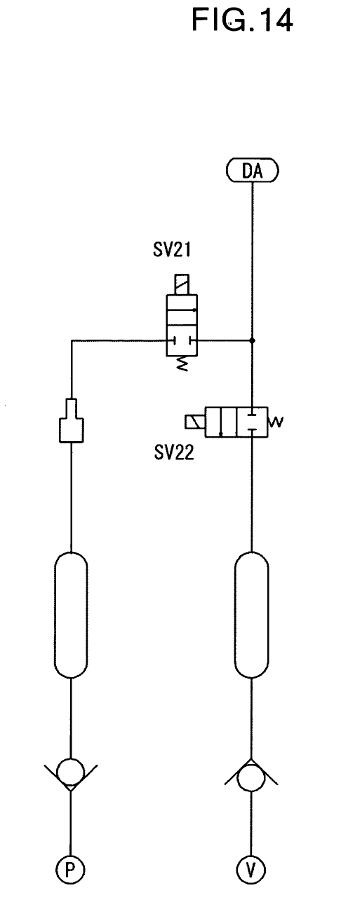

FIGS. 11-14 are fluid circuit diagrams showing composition of the fluid circuit of the specimen analyzer S relating to the present embodiment. In FIGS. 11-14, SP1 and SP2 are syringe pumps for sucking or supplying a sample (blood), CS is washing unit for washing the suction tube, and DP1-DP5 are diaphragm pumps for quantitative determination of liquids such as diluting fluid, hemolytic agent, staining fluid or the like. Further, WC1-WC2 are drainage chambers, EPK-C is EPK (diluting fluid) container, SV1-SV33 are electromagnetic valves for flow path opening/closing. These valves SV1˜SV33 are normally-closed type valves.

As illustrated, the suction tube 13 is connected to the syringe pump SP1 via a tube and when the syringe pump SP1 functions, it is possible to suck a specimen by applying a negative pressure to the suction tube 13. Further, it is possible to supply washing solution being supplied to the syringe pump SP1 by driving the diaphragm pump DP1 to the suction tube 13 by syringe pump SP1 operation. Besides, to the supplying path 16 of the washing unit CS, it is connected to a container EPK-C via a tube so as to receive from the container EPK-C the washing solution. The drainage path 17 of the washing unit CS is connected to the drainage chamber WC1 via a tube. This drainage chamber WC1 is connected to a vacuum pump V via a chamber for buffering purpose of drainage spilled out the drainage chamber WC1 and the drainage (washing solution, blood) is sucked by applying a negative pressure to the drainage path 17 by this vacuum pump via the drainage chamber WC1.

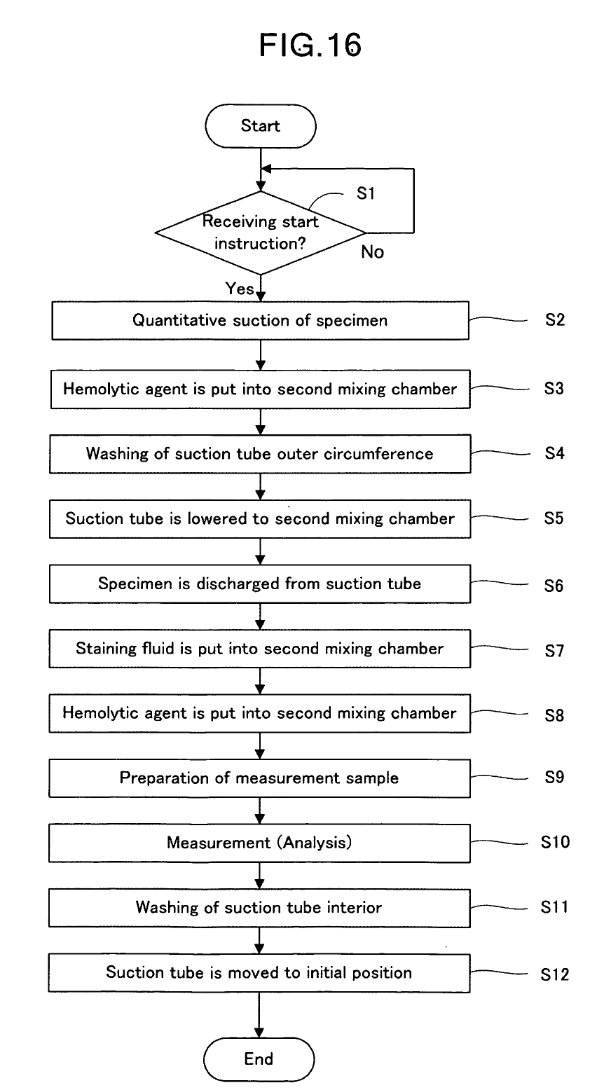

Next, referring to fluid circuit diagrams shown in FIGS. 11-14 and to flow chart shown in FIG. 16, operations of the specimen analyzer S relating to the embodiment according to the present invention will be explained. The following description deals with, as one example of operations of the specimen analyzer S, analysis operation of white blood cells contained in a specimen. First, the specimen analyzer S is in stand-by state where the suction tube 13 is located at the lower limit and is protruded downwardly from upper plane of the recess 5. Hereafter, this position of the suction tube 13 is referred to as the initial position. Namely, at this initial position, the suction tube 13 is exposed outside. Besides, when the suction tube 13 is in stand-by at the initial position, inside of the suction tube 13 is filled with a washing solution. Filling of the washing solution into the suction tube 13 will be descried later. When the suction tube 13 is at the initial position, the operator holds the blood-collection tube 3 by hand and lifts the blood-collection tube 3 upwardly from a position under the suction tube 3. By this manipulation, the suction tube 13 is inserted into the blood-collection tube 3.

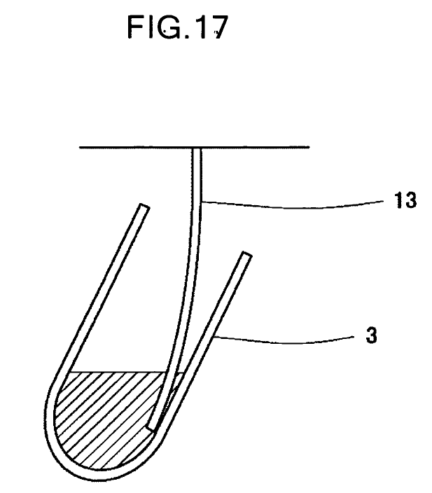

In this case, the operator moves the blood-collection tube 3 while the suction tube 13 is being inserted, pushes lower end of the suction tube 13 by inner wall of the blood-collection tube 3, and lower end of the suction tube 13 may hit bottom of the blood-collection tube. If this is the case, the suction tube 13 is exposed to an external force thereby resulting in deformation. FIG. 17 is a schematic diagram showing an example of deformation of the suction tube 13. As illustrated, when the suction tube 13 comes in contact with inner face of blood-collection tube 3 and a part of the suction tube 13 (e.g., lower end) is pressed, the suction tube 13 will be bent. The suction tube 13 is made of superelastic alloy and hence is bent easily, and when the external force is removed by that the blood-collection tube 3 is removed from the suction tube 13 or the like, it returns to its original straight profile by elasticity thereof.

While the suction tube 13 is being inserted to the blood-collection tube 3 and lower end of the suction tube 13 is immersed into the specimen, the operator touches a start switch 6 to initiate suction operation. Upon receiving such suction start instruction (Yes in step S1), the control unit 100 drives the syringe pump SP1 to cause quantitative suction of a predetermined amount of sample (step S2), while position of the suction tube 13 is not moved, namely, the suction tube 13 is remained at the initial position. At the same time, a hemolytic agent is supplied from the hemolytic agent container FFD-V to the second mixing chamber MC2 (step 3). In the meantime, here, supplying of the hemolytic agent to the second mixing chamber MC2 is not necessarily executed after suction of the sample (specimen), and these operations are performed at the same time. Although, for the sake of simplified explanation, each of operations is explained to be executed sequentially in the following description, a part of operations is executed simultaneously.

In step S3, specifically, by opening valve SV19 and closing valve SV20, and at the same time, by opening valve SV22 and closing valve S21, diaphragm pump D4 for FFD is negative pressure driven, and hemolytic agent FFD is replenished from the hemolytic agent container FFD-V to the diaphragm pump D4 for FFD. Further, by closing valve SV19 and opening valve SV20, and at the same time, by opening valve S21 and closing valve S22, diaphragm pump D4 for FFD is positive pressure driven, and hemolytic agent FFD is supplied by the diaphragm pump D4 to the second mixing chamber MC2. Furthermore, by opening valve S19 and closing valve S20, and at the same time, by closing valve S21 and opening valve S22, the diaphragm pump D4 for FFD is negative pressure driven, and hemolytic agent FFD is again replenished from the hemolytic agent container FFD-V to the diaphragm pump D4 for FFD.

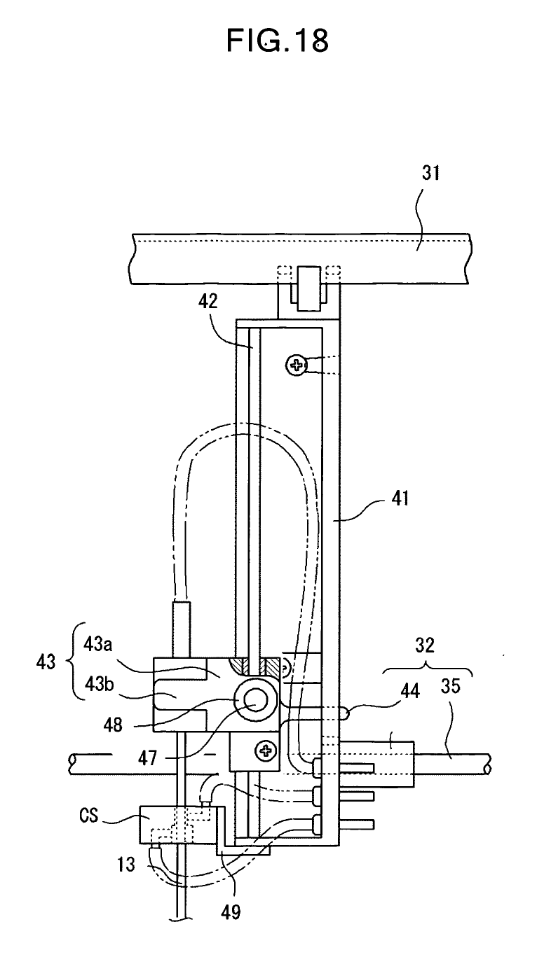

Subsequently, the suction tube 13 is moved up by operations of the horizontal driving unit 20 and vertical driving unit 30, and at the same time, washing of the suction tube 13 is carried out (step S4). FIG. 18 is a front view of the vertical driving unit 20 and the horizontal driving unit 20 showing positional relationship between the suction tube 13 and the washing unit CS when the suction tube 13 is at the initial position. As illustrated, when the suction tube 13 is at the initial position, the suction tube retaining part 43 is located in proximity to the washing unit CS, and the washing unit CS will be located around upper end of the suction tube 13. Specifically, step S4 means that the suction tube 13 is in such initial state, and the first drainage chamber WC1 is put into negative pressure state by closing valve SV15 and valve SV23, and opening valve SV14. Following this, the suction tube 13 is moved up, and valve SV11 and valve SV51 are opened, and outer circumference of the suction tube 13 is washed simultaneously with moving-up operation of the suction tube 13. In this instance, a washing solution is supplied from the supplying path 16 of the washing unit CS to inside of the penetrating path 15 and at the same time, the washing solution and sample (specimen) in the penetrating path 15 are discharged from the drainage path 17 by negative pressure. For the suction tube 13, by this moving-up operation, front edge of the suction tube 13 (suction port) is moved up to a position located inside the washing unit CS (hereinafter referred to as the upper limit position). As mentioned, washing of the suction tube 13 by the washing unit CS is carried out while the suction tube 13 is being moved from the initial position to the upper limit position, and therefore, the suction tube can be washed along with substantially total length thereof.

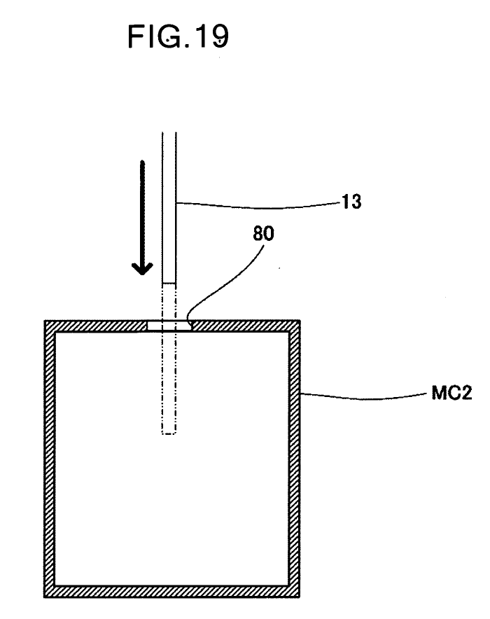

The suction tube 13 is then lowered to the second mixing chamber MC2 (step S5). FIG. 19 is a side sectional view showing state where the suction tube 13 is inserted into upper opening of the second mixing chamber MC2. As illustrated, an insertion port 80 for allowing insertion of the suction tube 13 is provided at upper part of the first mixing chamber MC2. This insertion port 80 has a size to permit insertion of insomuch as the suction tube 13 and should be made small as much as possible to prevent entry of foreign matters or the like. Accordingly, the insertion port 80 has a circular form slightly greater than outside diameter of the suction tube 13. In step S5, the suction tube 13 is positioned at upper portion of the insertion port 80 and the suction tube 13 is lowered from this position and then, front edge of thesuction tube 13 reaches from the insertion port 80 till interior of the second mixing chamber MC2. In this instance, the suction tube 13 is in straight state since it is made of superelastic alloy, which ensures positive insertion of the suction tube 13 into the insertion port 80. An insertion port is provided similarly to the first mixing chamber MC1, drainage chambers WC1-WC3, while explanation thereof is omitted here.

When the syringe pump SP1 is driven while the suction tube 13 is being inserted into the suction port 80 as mentioned, whole blood sample (a part of sample sucked in step S2) is discharged from suction port of the suction tube 13 to the second mixing chamber MC2 (step S6).

Upon completion of discharging, a staining fluid FFS is put into the second mixing chamber MC2 (step S7). Specifically, in step S7, by opening valve SV22 and at the same time, closing valve SV21 while staining fluid replenishment valve 40 is opened and staining fluid supply valve SV41 is closed, diaphragm pump DP5 for staining fluid supplying (diaphragm pump for FFS) is negative pressure driven, and staining fluid FFS is replenished to diaphragm pump DP5 for FFS. Further, if the diaphragm pump DP5 for FFS is positive pressure driven by closing valve SV40 and opening valve SV41, and at the same time, by opening valve SV21 and closing valve SV22, the staining fluid FFS is put into the second mixing chamber MC2.

Subsequently, hemolytic agent FFD is put into the second mixing chamber MC2 (step S8). Namely, the hemolytic agent FFD is put into the second mixing chamber MC2 by closing valve SV22, valve SV19, by opening valve SV21, valve SV20, and by using the diaphragm pump DP4 for FFD; and by preparing the whole blood sample through inflow stirring, a measurement sample, in which red blood cells are lysed and white blood cells are stained, is prepared in the second mixing chamber MC (step S9).

Measurement (analysis) is then carried out by the WBC detection unit D3 targeting the measurement sample (step S10). Specifically, in step S10, a diaphragm pump DP2 for charging is driven by opening valve SV4, valve SV29, valve SV22, and closing valve SV21, and measurement sample is charged accurately by a predetermined amount. Then valve SV4, valve SV29, valve SV22 are closed to complete charging to the WBC detection unit D3. After that, by opening valve SV9, valve SV31, sheath liquid (diluting fluid) EPK is supplied from the EPK container EPK-C to the WBC detection unit. Subsequently, valve SV3 is opened while valve SV1 is closed, sample supply syringe pump SP2 is driven, and measurement is taken in the WBC detection unit D3.

In above-mentioned measurement, the sample analyzer S prepares a measurement sample by mixing whole blood sample, hemolytic agent for white blood cell classification and staining fluid for white blood cell classification, and this measurement sample is measured by the optical detection unit D3 by flow cytometry technique. Measurements here include measurement of white blood cell count and five classifications of white blood cells.

In addition, washing of interior of the suction tube 13 is performed (step S11). Specifically, in step S11, the suction tube 13 is moved by operations of the horizontal driving unit 20 and vertical driving unit 30 and is lowered to the first mixing chamber MC1. Following this, by opening valve SV22 and by closing valve SV21 while valve SV32 and valve SV33 are being opened, the diaphragm pump DP1 is negative pressure driven, and diluting fluid is replenished to the diaphragm pump DP1. Then, valve SV22 is closed and valve SV21, valve SV15, valve SV16 are opened, and after that, valve SV15 is closed. By these manipulations, positive pressure is applied to the diaphragm pump DP1, and sample suction line (tube) and the suction tube 13 inside are then filled with washing solution. In this instance, surplus washing solution is discharged from suction port of the suction tube 13 to the first mixing chamber MC1. Interior of the suction tube 13 is thus washed. Drainaged is charged to the-first mixing chamber is drained to the drainage chamber WC1 by opening valve SV23. At this time, inside of the suction tube 13 and sample supplying line are filled with the diluting fluid. It is then sucked by the syringe pump SP1 under this state and an air gap is formed at front edge of the suction tube 13. The suction tube 13 is then moved to the initial position by operations of the horizontal driving unit 20 and vertical driving unit 30 (step S12).

As described in detail above, with the specimen analyzer S relating to the present embodiment, the suction tube 13 is made of superelastic alloy, and when the operator holds the blood-collection tube 3 and locates it to blood-collection position, the suction tube 13 maybe deformed easilyby contacting inner wall of the blood-collection tube to the suction tube 13, and therefore, the operator is able to check visually front edge of the suction tube with ease. Accordingly, even if the suction tube 13 is subjected to an external force, the suction tube 13 made of superelastic alloy returns immediately to its original straight profile, if the external force is removed. Therefore, when the suction tube 13 advances through the penetrating path 15 of the washing unit CS, the suction tube 13 is in straight state, and is able to advance smoothly in the washing unit CS, thereby ensuring washing of the suction tube 13. Besides, it is possible to insert the suction tube 13 surely into the first mixing chamber MC1, second mixing chamber MC2 or an opening at upper part of the drainage chambers WC1-WC3. Further, since the suction tube is made of superelastic alloy, there is no opportunity to become swollen by absorbing moisture as frequently experienced with synthetic resin or the like, thereby securing higher accuracy of quantitative determination.

In the present embodiment, such a composition is explained above that the washing unit CS is fixed to the horizontal driving unit 20 and the suction tube 13 is driven by the vertical driving unit 20, and outer circumference of the suction tube 13 is washed by the washing unit CS while the suction tube 13 is being moved up. However, the composition is not limited to this, and the washing unit CS may be moved up and down while the suction tube 13 is fixed, or both the suction tube 13 and the washing unit CS may be moved up and down. Alternatively, such a composition that the suction tube 13 is washed by the washing unit CS while the suction tube 13 is being lowered may be used.

In addition, such a composition is used that interior of the suction tube 13 is washed and at the same time, washing solution is filled to the interior of the suction tube 13, by supplying washing solution to interior of the suction tube 13, and therefore, it is not only possible to wash interior as well as outer circumference of the suction tube 13, but also to execute quantitative determination of a specimen with higher accuracy by filling the suction tube 13 with washing solution.

Further, since such a composition is provided that the washing unit CS is fixed to the horizontal driving unit 20, and the washing unit CS is moved horizontally together with the suction tube 13 in integrated fashion, while the suction tube 13 is being penetrated through the washing unit CS, when the suction tube 13 is to be washed, there is no need for accurate positioning so that the suction tube 13 is inserted into the penetrating path 15 of the washing unit CS.

Besides, the start switch 6, which receives specimen suction start instruction from the operator, is disposed in the vicinity of the suction tube 13, and therefore, when the operator moves the blood-collection tube 3 to the position where the suction tube 13 is inserted into the blood-collection tube 3 (suction position), the operator is able to manipulate the start switch with the hand holding the blood-collection tube 3, and the operator is able to set the blood-collection tube to the suction position and to give suction start instruction easily and consecutively, thereby providing operability convenient to the operator.

The foregoing detailed description and accompanying drawings have been provided by way of explanation and illustration, and are not intended to limit the scope of the appended claims. Many variations in the presently preferred embodiments illustrated herein will be obvious to one of ordinary skill in the art, and remain within the scope of the appended claims and their equivalents.

What is claimed is:

1. A specimen analyzer comprising:
a suction tube made of superelastic alloy for sucking a specimen from a specimen container whose upper portion is open;
a sample preparation unit having an insertion port for inserting the suction tube and preparing a sample by a specimen which is discharged from the suction tube inserted into the insertion port;
a movement mechanism for moving said suction tube between suction position for said suction tube to suck a specimen and insertion position where said suction tube is inserted into insertion port of said sample preparation unit; and
an analysis unit for analyzing a sample prepared by said sample preparation unit.

2. The specimen analyzer according to claim 1, further comprising:
a washing unit having a penetrating path through which is penetrating said suction tube, a supplying path for supplying washing solution to said penetrating path and a drainage path for draining the washing solution from said penetrating path.

3. The specimen analyzer according to claim 2, wherein said movement mechanism is configured so as to move relatively said suction tube and said washing unit in lengthwise direction of said suction tube.

4. The specimen analyzer according to claim 1, further comprising a supply unit for supplying washing solution to interior of said suction tube, wherein interior of said suction tube is washed and filled with washing solution by supplying washing solution to interior of said suction tube by the supply unit.

5. The specimen analyzer according to claim 2, wherein when said suction tube is moved by said movement mechanism, said washing unit is moved integrally with said suction tube.

6. The specimen analyzer according to claim 1, further comprising a quantitative suction unit connected to said suction tube for sucking a determinate quantity of specimen by said suction tube.

7. The specimen analyzer according to claim 6, further comprising:
an instruction receiving unit for receiving an instruction for specimen suction start; and
a control unit for controlling operations of said quantitative suction unit and said movement mechanism, wherein said control unit, when said instruction receiving unit receives an instruction for suction start, controls said quantitative suction unit so as to suck a specimen by said suction tube, while said suction tube is remained being stopped.

8. The specimen analyzer according to claim 1, wherein said suction tube is made of titanium-nickel alloy, copper-aluminum-nickel alloy, or titanium alloy.

9. The specimen analyzer according to claim 1, wherein said specimen is a blood specimen.

10. A specimen analyzer comprising:
a suction tube made of superelastic alloy for sucking a specimen from a specimen container whose upper portion is open;
a washing unit having a penetrating path through which is penetrating said suction tube, a supplying path for supplying washing solution to said penetrating path and a drainage path for draining the washing solution from said penetrating path;
a movement mechanism for relatively moving said suction tube and said washing unit in lengthwise direction of said suction tube; and
an analysis unit for analyzing a specimen sucked by said suction tube.

11. The specimen analyzer according to claim 10, wherein when said suction tube is moved by said movement mechanism, said washing unit is moved integrally with said suction tube.

12. The specimen analyzer according to claim 10, further comprising:
a suction mechanism connected to said suction tube for causing said suction tube to suck a specimen by giving negative pressure thereto;
an instruction receiving unit for receiving an instruction for specimen suction start; and
a control unit for controlling operations of said suction mechanism and said movement mechanism, wherein said control unit, when said instruction receiving unit receives an instruction for suction start, controls said suction mechanism so as to suck a specimen by said suction tube, while said suction tube is remained being stopped.

13. The specimen analyzer according to claim 10, further comprising:
a quantitative suction unit connected to said suction tube for sucking a determinate quantity of specimen by said suction tube.
a supply unit for supplying washing solution to interior of said suction tube, wherein interior of said suction tube is washed and filled with washing solution by supplying washing solution to interior of said suction tube by the supply unit.

14. The specimen analyzer according to claim 10, wherein said suction tube is made of titanium-nickel alloy, copper-aluminum-nickel alloy, or titanium alloy.

15. The specimen analyzer according to claim 10, wherein said specimen is a blood specimen.

16. A specimen suction device comprising:
a suction tube made of superelastic alloy for sucking a specimen from a specimen container whose upper portion is open;
a movement mechanism for moving said suction tube; and
a specimen suction unit connected to said suction tube for sucking a specimen by said suction tube.

17. The specimen suction device according to claim 16, further comprising:
a supply unit for supplying washing solution to interior of said suction tube, wherein interior of said suction tube is washed and filled with washing solution by supplying washing solution to interior of said suction tube by the supply unit.

18. The specimen suction device according to claim 16, wherein said specimen suction unit is configured so as to suck a determinate quantity of specimen by said suction tube.

19. The specimen suction device according to claim 16, wherein said suction tube is made of titanium-nickel alloy, copper-aluminum-nickel alloy, or titanium alloy.

20. The specimen suction device according to claim 16, wherein said specimen is a blood specimen.
